(19) United States
(12) Patent Application Publication
(10) Pub. No.: US 2026/0219748 A1
(43) Pub. Date: Jul. 30, 2026

(54) THERMALLY ACTIVE MOUSE PAD DEVICE

(71) Applicant: Opeyemi Adesanya, McKinney, TX (US)

(72) Inventor: Opeyemi Adesanya, McKinney, TX (US)

(21) Appl. No.: 19/041,515

(22) Filed: Jan. 30, 2025

(51) Int. Cl. G06F 3/039; H05B 3/36

(52) U.S. Cl. CPC G06F 3/0395; H05B 3/36

(57) ABSTRACT

A thermally active mouse pad device includes a mouse pad that can be positioned on a work surface such that the mouse pad is accessible to the user. A wrist pad is coupled to the mouse pad to support a wrist of the user. A heating element is integrated into the wrist pad to heat the wrist of the user when the heating element is turned on. A cooling element is integrated into the wrist pad to cool the wrist of the user when the cooling element is turned on. A first power port and a second power port is each recessed into the wrist pad to insertably receive a power cord. The second power cord is positioned on an opposite end of the wrist pad from the first power port to allow the user the option of plugging the power cord into either end of the wrist pad.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to mouse pad devices and more particularly pertains to a new mouse pad device for either heating or cooling a wrist of a user. The device includes a mouse pad and a wrist pad that is attached to the mouse pad to support a wrist of a user. The device includes a heating element integrated into the wrist pad to warm the wrist of the user when the heating element is turned on. The device includes a cooling element integrated into the wrist pad to cool the wrist of the user. The device includes a first power port and a second power port each recessed into opposing ends of the wrist pad from each other. A power cord can be plugged into either the first power port or the second power port, depending on a preference of the user.

### (2) Description of Related Art Including Information Disclosed Under 37 CFR 1.97 and 1.98

The prior art relates to mouse pad devices including: a therapeutic wrist device which includes a cushion upon which a computer keyboard can be positioned and a heating element integrated into the cushion to warm the cushion and a vibration unit integrated into the cushion for vibrating the cushion; a variety of mouse pad devices that each at least includes a mouse pad and a heating element integrated into the mouse pad for warming a wrist of a user when the user employs the mouse pad. In no instance does the prior art disclose a thermally active mouse pad device that includes a mouse pad and a wrist pad attached to the mouse pad and a heating element integrated into the wrist pad for heating a wrist of a user and a cooling element integrated into the wrist pad for cooling the wrist of the user.

### BRIEF SUMMARY OF THE INVENTION

An embodiment of the disclosure meets the needs presented above by generally comprising a mouse pad that can be positioned on a work surface such that the mouse pad is accessible to the user. A wrist pad is coupled to the mouse pad to support a wrist of the user. A heating element is integrated into the wrist pad to heat the wrist of the user when the heating element is turned on. A cooling element is integrated into the wrist pad to cool the wrist of the user when the cooling element is turned on. A first power port and a second power port is each recessed into the wrist pad to insertably receive a power cord. The second power cord is positioned on an opposite end of the wrist pad from the first power port to allow the user the option of plugging the power cord into either end of the wrist pad.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top phantom view of a thermally active mouse pad device according to an embodiment of the disclosure.

FIG. 2 is a top perspective view of an embodiment of the disclosure.

FIG. 3 is a left side view of an embodiment of the disclosure.

FIG. 4 is a cross sectional view taken along line 4-4 of FIG. 3 of an embodiment of the disclosure.

FIG. 5 is a perspective in-use view of an embodiment of the disclosure.

FIG. 6 is a schematic view of an embodiment of the disclosure.

### DETAILED DESCRIPTION OF THE INVENTION

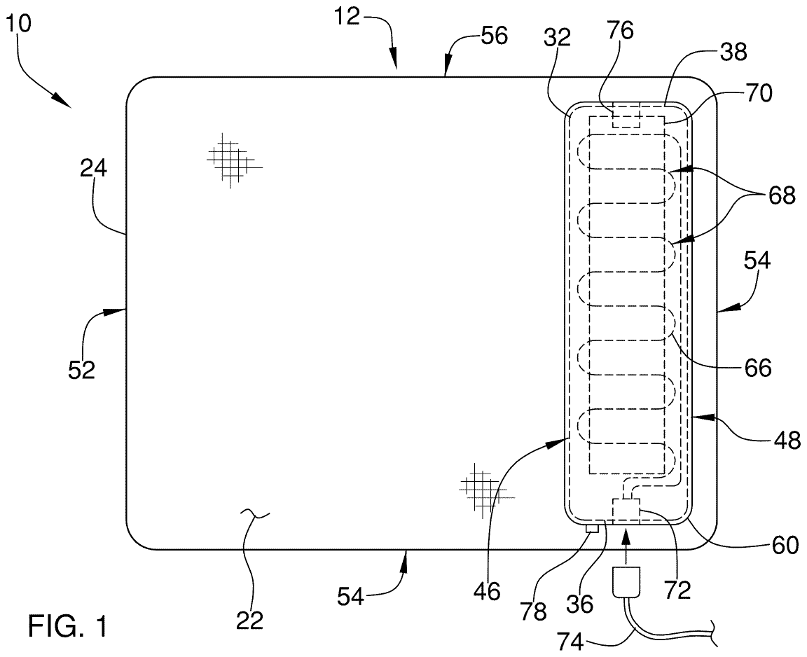

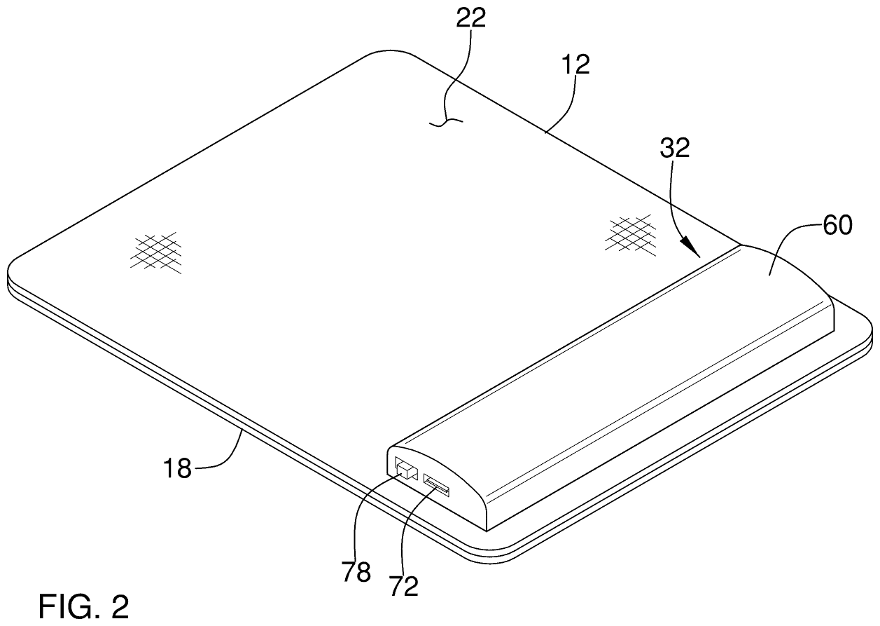

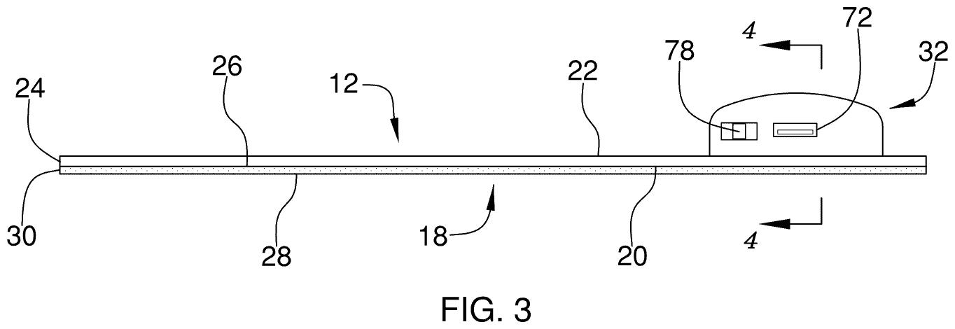

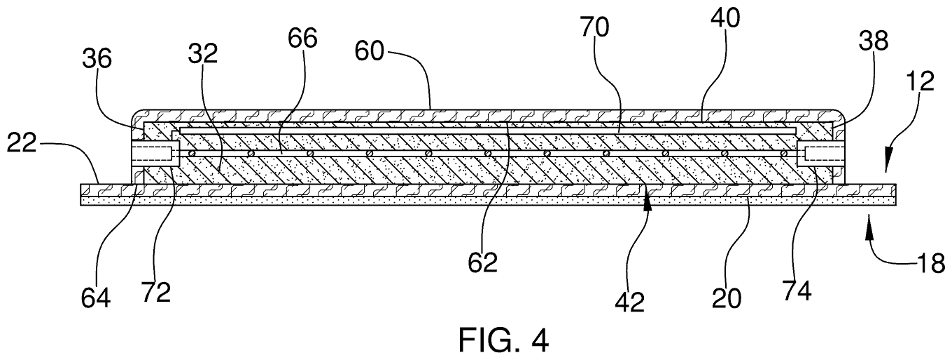

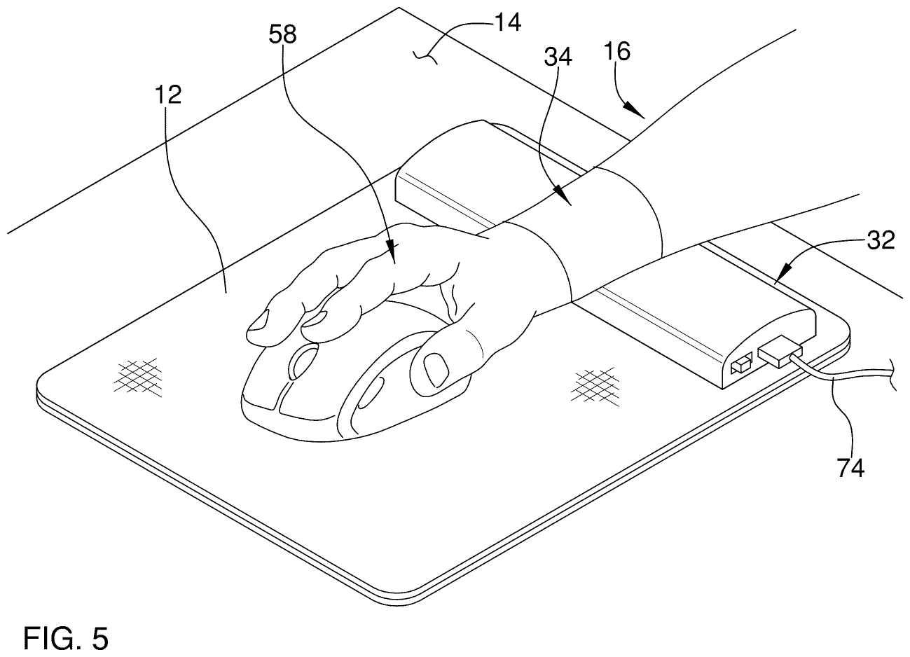

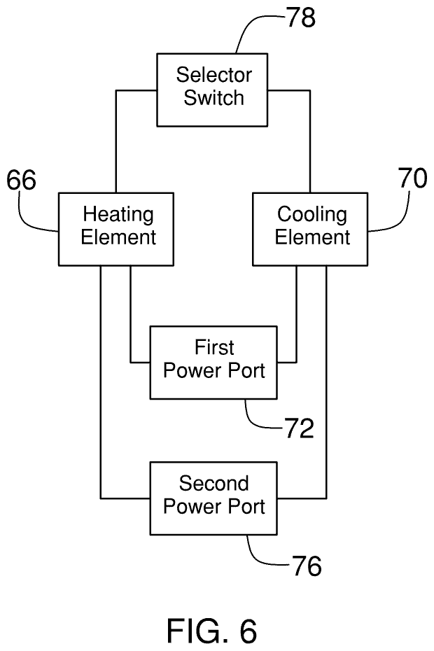

With reference now to the drawings, and in particular to FIGS. 1 through 6 thereof, a new mouse pad device embodying the principles and concepts of an embodiment of the disclosure and generally designated by the reference numeral 10 will be described.

As best illustrated in FIGS. 1 through 6, the thermally active mouse pad device 10 generally comprises a mouse pad 12 which can be positioned on a work surface 14 such that the mouse pad 12 is accessible to the user 16. The work surface 14 may comprise a desktop or other type of horizontal support surface. The mouse pad 12 is comprised of a light absorbing material, including but not being limited to darkened rubber, such that the mouse pad 12 does not disrupt the function of an optical mouse which is positioned upon the mouse pad 12. Furthermore, the light absorbing material is comprised of a resiliently compressible material to enhance comfort for the user 16.

A friction pad 18 is coupled to the mouse pad 12 such that the friction pad 18 rests upon the work surface 14 when the mouse pad 12 is positioned on the work surface 14. The friction pad 18 is comprised of a friction enhancing material, including but not being limited rubber or silicone, such that the friction pad 18 can frictionally engage the work surface 14 to inhibit the mouse pad 12 from sliding on the work surface 14. The mouse pad 12 has a bottom surface 20 and a top surface 22; the mouse pad 12 has a perimeter edge 24 extending between the top surface 22 and the bottom surface 20. The friction pad 18 has an upper surface 26 and a lower surface 28; the friction pad 18 has a perimeter edge 30 extending between the upper surface 26 and the lower surface 28. The upper surface 26 is coupled to the bottom surface 20 of the mouse pad 12 such that the lower surface 28 rests upon the work surface 14 and the upper surface 26 completely covers the bottom surface 20. The perimeter edge 30 of the friction pad 18 is aligned with the perimeter edge 24 of the mouse pad 12 and the perimeter edge 30 of the friction pad 18 is coextensive with the perimeter edge 24 of the mouse pad 12.

A wrist pad 32 is coupled to the mouse pad 12 such that a wrist 34 of the user 16 positioned upon the wrist pad 32 when the user 16 is employing the optical mouse on the mouse pad 12. The wrist pad 32 extends upwardly from the mouse pad 12 such that the wrist pad 32 supports the wrist 34 of the user 16 for reducing fatigue in the wrist 34 of the user 16. The wrist pad 32 is comprised of a resiliently compressible material, including but not being limited to a viscoelastic polyurethane foam or a low resilience polyurethane foam, such that the wrist pad 32 can enhance comfort of the user 16 when the wrist 34 of the user 16 is positioned on the wrist pad 32. The wrist pad 32 has a first end 36 and a second end 38; the wrist pad 32 is elongated between the first end 36 and the second end 38. The wrist pad 32 has an outer surface 40 extending between the first end 36 and the second end 38; the outer surface 40 has a bottom side 42 and a top side 44 and the outer surface 40 has a front side 46 and a back side 48 each extending between the bottom side 42 of the outer surface 40 and the top side 44 of the outer surface 40. The top side 44 of the outer surface 40 curves upwardly between each of the front side 46 and the back side 48 such that the wrist pad 32 has a Quonset shape. Furthermore, the top side 44 of the outer surface 40 conforms to a shape of the wrist 34 of the user 16 when the wrist 34 of the user 16 is positioned on the top side 44 of the outer surface 40.

The perimeter edge 24 of the mouse pad 12 has a rear side 50 and a forward side 52; the perimeter edge 24 of the mouse pad 12 has a first lateral side 54 and a second lateral side 56. Each of the first lateral side 54 and the second lateral side 56 extends between and is perpendicular to the rear side 50 and the forward side 52. The bottom side 42 of the outer surface 40 of the wrist pad 32 is coupled to the top surface 22 of the mouse pad 12. The wrist pad 32 is oriented such that the first end 36 of the wrist pad 32 is spaced from and is oriented parallel to the first lateral side 54 of the perimeter edge 24 of the mouse pad 12. Additionally, the wrist pad 32 is oriented such that the second end 38 of the mouse pad 12 is spaced from and is oriented parallel to the second lateral side 56 of the perimeter edge 24 of the mouse pad 12. The wrist pad 32 is positioned closer to the rear side 50 of the perimeter edge 24 of the mouse pad 12 than the forward side 52 of the perimeter edge 24 of the mouse pad 12 such that the wrist pad 32 places a hand 58 of the user 16 in front of the wrist pad 32 when the wrist 34 of the user 16 is positioned on the top side 44 of the outer surface 40 of the wrist pad 32. Furthermore, the wrist pad 32 is oriented such that the back side 48 of the outer surface 40 of the wrist pad 32 is oriented parallel to the rear side 50 of the perimeter edge 24 of the mouse pad 12.

A cover 60 is positioned over the wrist pad 32 and the cover 60 is coupled to the mouse pad 12 such that the cover 60 encloses the wrist pad 32. The cover 60 has a lowermost surface 62 and a coupled edge 64. The lowermost surface 62 is coupled to the top side 44 of the outer surface 40 of the wrist pad 32 and the lowermost surface 62 is coupled to the front side 46 of outer surface 40 of the wrist pad 32. The lowermost surface 62 is coupled to the first end 36 of the wrist pad 32 and the lowermost surface 62 is coupled to the second end 38 of the wrist pad 32. Additionally, the coupled edge 64 is coupled to the top surface 22 of the mouse pad 12 and the coupled edge 64 extends around a full perimeter of the bottom side 42 of the outer surface 40 of the wrist pad 32.

A heating element 66 is integrated into the wrist pad 32 and the heating element 66 is in thermal communication with the wrist pad 32. The resiliently compressible material of the wrist pad 32 comprises a thermally conductive material. Furthermore, the heating element 66 heats the wrist pad 32 when the heating element 66 is turned on such that the heating element 66 heats the wrist 34 of the user 16 when the wrist 34 of the user 16 is positioned on the wrist pad 32. The action of heating the wrist 34 of the user 16 can potentially relieve the symptoms of arthritis in the wrist 34 of the user 16, for example, or other type of physiological condition that can be relieved with heat.

The heating element 66 is elongated to extend a partial distance between the first end 36 and the second end 38 of the wrist pad 32 and the heating element 66 is positioned between the top side 44 of the outer surface 40 of the wrist pad 32 and the bottom side 42 of the outer surface 40 of the wrist pad 32. Furthermore, the heating element 66 comprises a series of coils 68 each extending a partial distance between the front side 46 of the outer surface 40 of the wrist pad 32 and the back side 48 of the outer surface 40 of the wrist pad 32. In addition, the series of coils 68 is evenly spaced apart from each other and is distributed along the partial distance the first end 36 of the wrist pad 32 and the second end 38 of the wrist pad 32. The heating element 66 may comprise an electronic heating element or the like which has an operational temperature ranging between approximately 100.0 degrees Fahrenheit and 160.0 degrees Fahrenheit.

A cooling element 70 is integrated into the wrist pad 32 and the cooling element 70 is in thermal communication with the wrist pad 32. Furthermore, the cooling element 70 cools the wrist pad 32 when the cooling element 70 is turned on such that the cooling element 70 cools the wrist 34 of the user 16 when the wrist 34 of the user 16 is positioned on the wrist pad 32. The cooling element 70 may be positioned between the heating element 66 and the top side 44 of the outer surface 40 of the wrist pad 32. Additionally, the cooling element 70 is elongated to extend between the first end 36 and the second end 38 of the wrist pad 32. The cooling element 70 may comprise a thermoelectric cooling element or the like and the cooling element 70 may have an operational temperature ranging between approximately 60.0 degrees Fahrenheit and 40.0 degrees Fahrenheit.

A first power port 72 is recessed into the wrist pad 32 and the first power port 72 can insertably receive a power cord 74. The first power port 72 is in electrical communication with the heating element 66 and the first power port 72 is in electrical communication with the cooling element 70. The first power port 72 is located on the first end 36 of the wrist pad 32 and the first power port 72 extends through a portion of the cover 60 which is positioned on the first end 36 of the wrist pad 32. Furthermore, the first power port 72 may comprise a universal serial bus port or other similar type of power port that is common to rechargeable electronic devices.

A second power port 76 is recessed into the wrist pad 32 and the second power port 76 can insertably receive the power cord 74. The second power port 76 is in electrical communication with the heating element 66 and the second power port 76 is in electrical communication with the cooling element 70. Additionally, the second power cord 74 is positioned on an opposite end of the wrist pad 32 with respect to the first power port 72 such that each of the first power port 72 and the second power port 76 allows the user 16 the option of plugging the power cord 74 into either end of the wrist pad 32. The second power port 76 is located on the second end 38 of the wrist pad 32 and the second power port 76 extends through a portion of the cover 60 which is positioned on the second end 38 of the wrist pad 32. Furthermore, the second power port 76 may comprise a universal serial bus port or other similar type of power port that is common to rechargeable electronic devices.

A selector switch 78 is movably integrated into the wrist pad 32 such that the selector switch 78 is accessible to the user 16. The selector switch 78 is in electrical communication with the heating element 66 and the selector switch 78 is in electrical communication with the cooling element 70. The selector switch 78 is positionable in an off position and each of the heating element 66 and the cooling element 70 is turned off when the selector switch 78 is in the off position. The selector switch 78 is positionable in a heating position and the heating element 66 is turned on when the selector switch 78 is positioned in the heating position. Additionally, the selector switch 78 is positionable in a cooling position and the cooling element 70 is turned on when the selector switch 78 is positioned in the cooling position. Furthermore, the selector switch 78 is located on the first end 36 of the wrist pad 32 and the selector switch 78 extends through the portion of the cover 60 which is positioned on the first end 36 of the wrist pad 32.

In use, the mouse pad 12 and the wrist pad 32 are employed on the work surface 14 when the user 16 wishes to employ a mouse 80. The power cord 74 is plugged into either the first power port 72 or the second power port 76, depending on the preference of the user 16. The selector switch 78 is positioned in the off position when the user 16 does not wish to actuate either the heating element 66 or the cooling element 70. The selector switch 78 is positioned in the heating position when the user 16 wishes to heat the wrist pad 32 thereby heating the wrist 34 of the user 16 while the wrist 34 of the user 16 is positioned on the wrist pad 32. The selector switch 78 is positioned in the cooling position thereby cooling the wrist pad 32 when the user 16 wishes to cool the wrist 34 of the user 16 while the wrist 34 of the user 16 is positioned on the wrist pad 32.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A thermally active mouse pad device for heating or cooling a wrist of a user, said device comprising:
a mouse pad being configured to be positioned on a work surface, said mouse pad being comprised of a light absorbing material wherein said mouse pad is configured to not disrupt the function of an optical mouse which is positioned upon said mouse pad;
a friction pad being coupled to said mouse pad wherein said friction pad is configured to rest upon the work surface when said mouse pad is positioned on the work surface, said friction pad being comprised of a friction enhancing material wherein said friction pad is configured to frictionally engage the work surface to inhibit said mouse pad from sliding on the work surface;
a wrist pad being coupled to said mouse pad wherein said wrist pad is configured to have the wrist of the user positioned upon said wrist pad when the user is employing the optical mouse on said mouse pad, said wrist pad extending upwardly from said mouse pad wherein said wrist pad is configured to support the wrist of the user for reducing fatigue in the wrist of the user, said wrist pad being comprised of a resiliently compressible material wherein said wrist pad is configured to cushion the wrist of the user when the wrist of the user is positioned on said wrist pad;
a heating element being integrated into said wrist pad, said heating element being in thermal communication with said wrist pad, said resiliently compressible material of said wrist pad comprising a thermally conductive material, said heating element heating said wrist pad when said heating element is turned on wherein said heating element is configured to heat the wrist of the user when the wrist of the user is positioned on said wrist pad;
a cooling element being integrated into said wrist pad, said cooling element being in thermal communication with said wrist pad, said cooling element cooling said wrist pad when said cooling element is turned on wherein said cooling element is configured to cool the wrist of the user when the wrist of the user is positioned on said wrist pad;
a first power port being recessed into said wrist pad wherein said first power port is configured to insertably receive a power cord, said first power port being in electrical communication with said heating element, said first power port being in electrical communication with said cooling element; and
a second power port being recessed into said wrist pad wherein said second power port is configured to insertably receive the power cord, said second power port being in electrical communication with said heating element, said second power port being in electrical communication with said cooling element, said second power cord being positioned on an opposite end of said wrist pad with respect to said first power port wherein each of said first power port and said second power port is configured to allow the user the option of plugging the power cord into either end of said wrist pad.

2. The thermally active mouse pad device according to claim 1, wherein:
said mouse pad has a bottom surface and a top surface;
said mouse pad has a perimeter edge extending between said top surface and said bottom surface;
said friction pad has an upper surface and a lower surface;
said friction pad has a perimeter edge extending between said upper surface and said lower surface;
said upper surface being coupled to said bottom surface of said mouse pad wherein said lower surface is configured to rest upon the work surface;
said upper surface completely covers said bottom surface;
said perimeter edge of said friction pad is aligned with said perimeter edge of said mouse pad; and
said perimeter edge of said friction pad is coextensive with said perimeter edge of said mouse pad.

3. The thermally active mouse pad device according to claim 2, wherein:
said wrist pad is positioned on said top surface of said mouse pad;
said wrist pad has a first end and a second end;
said wrist pad is elongated between said first end and said second end;
said wrist pad has an outer surface extending between said first end and said second end;
said outer surface has a bottom side and a top side;
said outer surface has a front side and a back side each extending between said bottom side of said outer surface and said top side of said outer surface; and
said top side of said outer surface curves upwardly between each of said front side and said back side such that said wrist pad has a Quonset shape wherein said top side of said outer surface is configured to conform to a shape of the wrist of the user when the wrist of the user is positioned on said top side of said outer surface.

4. The thermally active mouse pad device according to claim 3, wherein:
said perimeter edge of said mouse pad has a rear side and a forward side;
said perimeter edge of said mouse pad has a first lateral side and a second lateral side;
each of said first lateral side and said second lateral side extends between and is perpendicular to said rear side and said forward side; and
said bottom side of said outer surface of said wrist pad is coupled to said top surface of said mouse pad.

5. The thermally active mouse pad device according to claim 4, wherein:
said wrist pad is oriented such that said first end of said wrist pad is spaced from and is oriented parallel to said first lateral side of said perimeter edge of said mouse pad; and
said wrist pad is oriented such that said second end of said mouse pad is spaced from and is oriented parallel to said second lateral side of said perimeter edge of said mouse pad.

6. The thermally active mouse pad device according to claim 4, wherein said wrist pad is positioned closer to said rear side of said perimeter edge of said mouse pad than said forward side of said perimeter edge of said mouse pad wherein said wrist pad is configured to be positioned to place a hand of the user in front of said wrist pad when the wrist of the user is positioned on said top side of said outer surface of said wrist pad.

7. The thermally active mouse pad device according to claim 4, wherein said wrist pad is oriented such that said back side of said outer surface of said wrist pad is oriented parallel to said rear side of said perimeter edge of said mouse pad.

8. The thermally active mouse pad device according to claim 3, wherein:
said thermally active mouse pad device includes a cover being positioned over said wrist pad;
said cover is coupled to said mouse pad such that said cover encloses said wrist pad;
said cover has a lowermost surface and a coupled edge;
said lowermost surface is coupled to said top side of said outer surface of said wrist pad;
said lowermost surface is coupled to said front side of outer surface of said wrist pad;
said lowermost surface is coupled to said first end of said wrist pad;
said lowermost surface is coupled to said second end of said wrist pad;
said coupled edge is coupled to said top surface of said mouse pad; and
said coupled edge extends around a full perimeter of said bottom side of said outer surface of said wrist pad.

9. The thermally active mouse pad device according to claim 3, wherein:
said heating element is elongated to a partial distance between said first end and said second end of said wrist pad; and
said heating element is positioned between said top side of said outer surface of said wrist pad and said bottom side of said outer surface of said wrist pad.

10. The thermally active mouse pad device according to claim 3, wherein:
said heating element comprises a series of coils each extending a partial distance between said front side of said outer surface of said wrist pad and said back side of said outer surface of said wrist pad; and
said series of coils is evenly spaced apart from each other and is distributed along a partial distance between said first end of said wrist pad and said second end of said wrist pad.

11. The thermally active mouse pad device according to claim 3, wherein:
said cooling element is positioned between said heating element and said top side of said outer surface of said wrist pad; and
said cooling element is elongated to extend a partial distance between said first end and said second end of said wrist pad.

12. The thermally active mouse pad device according to claim 8, wherein:
said first power port is located on said first end of said wrist pad; and
said first power port extends through a portion of said cover which is positioned on said first end of said wrist pad.

13. The thermally active mouse pad device according to claim 8, wherein:
said second power port is located on said second end of said wrist pad; and
said second power port extends through a portion of said cover which is positioned on said second end of said wrist pad.

14. The thermally active mouse pad device according to claim 1, wherein:
said thermally active mouse pad device includes a selector switch being movably integrated into said wrist pad wherein said selector switch is configured to be accessible to the user;
said selector switch is in electrical communication with said heating element;
said selector switch is in electrical communication with said cooling element;
said selector switch is positionable in an off position; and
each of said heating element and said cooling element being turned off when said selector switch is in said off position.

15. The thermally active mouse pad device according to claim 14, wherein:
said selector switch is positionable in a heating position; and
said heating element is turned on when said selector switch is positioned in said heating position.

16. The thermally active mouse pad device according to claim 14, wherein:
said selector switch is positionable in a cooling position; and
said cooling element is turned on when said selector switch is positioned in said cooling position.

17. The thermally active mouse pad device according to claim 8, wherein:
said thermally active mouse pad device includes a selector switch;
said selector switch is located on said first end of said wrist pad; and
said selector switch extends through said portion of said cover which is positioned on said first end of said wrist pad.

18. A thermally active mouse pad device for heating or cooling a wrist of a user, said device comprising:
a mouse pad being configured to be positioned on a work surface, said mouse pad being comprised of a light absorbing material wherein said mouse pad is configured to not disrupt the function of an optical mouse which is positioned upon said mouse pad;
a friction pad being coupled to said mouse pad wherein said friction pad is configured to rest upon the work surface when said mouse pad is positioned on the work surface, said friction pad being comprised of a friction enhancing material wherein said friction pad is configured to frictionally engage the work surface to inhibit said mouse pad from sliding on the work surface, said mouse pad having a bottom surface and a top surface, said mouse pad having a perimeter edge extending between said top surface and said bottom surface, said friction pad having an upper surface and a lower surface, said friction pad having a perimeter edge extending between said upper surface and said lower surface, said upper surface being coupled to said bottom surface of said mouse pad wherein said lower surface is configured to rest upon the work surface, said upper surface completely covering said bottom surface, said perimeter edge of said friction pad being aligned with said perimeter edge of said mouse pad, said perimeter edge of said friction pad being coextensive with said perimeter edge of said mouse pad;
a wrist pad being coupled to said mouse pad wherein said wrist pad is configured to have the wrist of the user positioned upon said wrist pad when the user is employing the optical mouse on said mouse pad, said wrist pad extending upwardly from said mouse pad wherein said wrist pad is configured to support the wrist of the user for reducing fatigue in the wrist of the user, said wrist pad being comprised of a resiliently compressible material wherein said wrist pad is configured to cushion the wrist of the user when the wrist of the user is positioned on said wrist pad, said wrist pad having a first end and a second end, said wrist pad being elongated between said first end and said second end, said wrist pad having an outer surface extending between said first end and said second end, said outer surface having a bottom side and a top side, said outer surface having a front side and a back side each extending between said bottom side of said outer surface and said top side of said outer surface, said top side of said outer surface curving upwardly between each of said front side and said back side such that said wrist pad has a Quonset shape wherein said top side of said outer surface is configured to conform to a shape of the wrist of the user when the wrist of the user is positioned on said top side of said outer surface, said perimeter edge of said mouse pad having a rear side and a forward side, said perimeter edge of said mouse pad having a first lateral side and a second lateral side, each of said first lateral side and said second lateral side extending between and being perpendicular to said rear side and said forward side, said bottom side of said outer surface of said wrist pad being coupled to said top surface of said mouse pad, said wrist pad being oriented such that said first end of said wrist pad is spaced from and is oriented parallel to said first lateral side of said perimeter edge of said mouse pad, said wrist pad being oriented such that said second end of said mouse pad is spaced from and is oriented parallel to said second lateral side of said perimeter edge of said mouse pad, said wrist pad being positioned closer to said rear side of said perimeter edge of said mouse pad than said forward side of said perimeter edge of said mouse pad wherein said wrist pad is configured to be positioned to place a hand of the user in front of said wrist pad when the wrist of the user is positioned on said top side of said outer surface of said wrist pad, said wrist pad being oriented such that said back side of said outer surface of said wrist pad is oriented parallel to said rear side of said perimeter edge of said mouse pad;
a cover being positioned over said wrist pad, said cover being coupled to said mouse pad such that said cover encloses said wrist pad, said cover having a lowermost surface and a coupled edge, said lowermost surface being coupled to said top side of said outer surface of said wrist pad, said lowermost surface being coupled to said front side of outer surface of said wrist pad, said lowermost surface being coupled to said first end of said wrist pad, said lowermost surface being coupled to said second end of said wrist pad, said coupled edge being coupled to said top surface of said mouse pad, said coupled edge extending around a full perimeter of said bottom side of said outer surface of said wrist pad;
a heating element being integrated into said wrist pad, said heating element being in thermal communication with said wrist pad, said resiliently compressible material of said wrist pad comprising a thermally conductive material, said heating element heating said wrist pad when said heating element is turned on wherein said heating element is configured to heat the wrist of the user when the wrist of the user is positioned on said wrist pad, said heating element being elongated to extend a partial distance between said first end and said second end of said wrist pad, said heating element being positioned between said top side of said outer surface of said wrist pad and said bottom side of said outer surface of said wrist pad, said heating element comprising a series of coils each extending a partial distance between said front side of said outer surface of said wrist pad and said back side of said outer surface of said wrist pad, said series of coils being evenly spaced apart from each other and being distributed along said partial distance said first end of said wrist pad and said second end of said wrist pad;
a cooling element being integrated into said wrist pad, said cooling element being in thermal communication with said wrist pad, said cooling element cooling said wrist pad when said cooling element is turned on wherein said cooling element is configured to cool the wrist of the user when the wrist of the user is positioned on said wrist pad, said cooling element being positioned between said heating element and said top side of said outer surface of said wrist pad, said cooling element being elongated to extend between said first end and said second end of said wrist pad;
a first power port being recessed into said wrist pad wherein said first power port is configured to insertably receive a power cord, said first power port being in electrical communication with said heating element, said first power port being in electrical communication with said cooling element, said first power port being located on said first end of said wrist pad, said first power port extending through a portion of said cover which is positioned on said first end of said wrist pad;
a second power port being recessed into said wrist pad wherein said second power port is configured to insertably receive the power cord, said second power port being in electrical communication with said heating element, said second power port being in electrical communication with said cooling element, said second power cord being positioned on an opposite end of said wrist pad with respect to said first power port wherein each of said first power port and said second power port is configured to allow the user the option of plugging the power cord into either end of said wrist pad, said second power port being located on said second end of said wrist pad, said second power port extending through a portion of said cover which is positioned on said second end of said wrist pad; and
a selector switch being movably integrated into said wrist pad wherein said selector switch is configured to be accessible to the user, said selector switch being in electrical communication with said heating element, said selector switch being in electrical communication with said cooling element, said selector switch being positionable in an off position, each of said heating element and said cooling element being turned off when said selector switch is in said off position, said selector switch being positionable in a heating position, said heating element being turned on when said selector switch is positioned in said heating position, said selector switch being positionable in a cooling position, said cooling element being turned on when said selector switch is positioned in said cooling position, said selector switch being located on said first end of said wrist pad, said selector switch extending through said portion of said cover which is positioned on said first end of said wrist pad.
